(19) United States
(12) Patent Application Publication
(10) Pub. No.: US 2005/0228624 A1
(43) Pub. Date: Oct. 13, 2005

(54) System and method for modeling of liquid displacement by a leading edge of a vessel

(76) Inventor: Lawrence M. Lachman, Dallas, TX (US)

Correspondence Address: FISH & RICHARDSON P.C., 1717 MAIN STREET, SUITE 5000, DALLAS, TX, 75201, US

(21) Appl. No.: 10/973,797

(22) Filed: Oct. 26, 2004

Related U.S. Application Data
(60) Provisional application No. 60/561,434, filed on Apr. 12, 2004.

(51) Int. Cl. G06G 7/48

(52) U.S. Cl. 703/9

(57) ABSTRACT

A system and method for modeling of liquid displacement by a leading edge of a vessel is provided. In one embodiment, a method for modeling liquid displaced by a leading edge of a vessel includes determining environmental information associated with the liquid and motional information associated with the leading edge of the vessel. A model of the liquid displaced by the leading edge of the vessel is generated based, at least in part, on the environmental and motional information.

### RELATED APPLICATION

This application claims the benefit of U.S. Provisional Application No. 60/561,434 filed Apr. 12, 2004.

### TECHNICAL FIELD

This disclosure relates to modeling and, more particularly, to a system and method for modeling of liquid displacement by a leading edge of a vessel.

### BACKGROUND

Modeling complex real objects typically requires developing complex software programs. The software programs include reusable classes, functions, routines, or subroutines that determine various attributes of a modeled object. For example, these tools may determine the geometry (e.g., shape, dimensions, and location) in combination with other attributes (e.g., color and texture) of the modeled object.

### SUMMARY

A system and method for modeling of liquid displacement by a leading edge of a vessel is provided. In one embodiment, a method for modeling liquid displaced by a leading edge of a vessel includes determining environmental information associated with the liquid and motional information associated with the leading edge of the vessel. A model of the liquid displaced by the leading edge of the vessel is generated based, at least in part, on the environmental and motional information.

In another embodiment, a method for modeling liquid displaced by a leading edge of a vessel includes identifying maneuvering information associated with the vessel. A bow wave associated with the vessel is dynamically modeled based, at least in part, on the maneuvering information.

In another embodiment, a method for modeling liquid displaced by a leading edge of a vessel includes generating a model of a bow wave for a vessel, the model representing water displaced by passing of the vessel and including a left and right components. The left and right bow waves are independently distorted based, at least in part, on motion of the ship. The details of one or more embodiments are set forth in the accompanying drawings and the description below. Other features, objects, and advantages of the disclosure will be apparent from the description and drawings, and from the claims.

### DESCRIPTION OF DRAWINGS

FIG. 1 is a block diagram of a modeling system for providing a visual simulation of water or other fluid displaced by a leading edge of a vessel;

FIGS. 2A-C illustrate polygonal meshes in accordance with the modeling system of FIG. 1;

FIGS. 3A-B illustrate a flow diagram implementing an example method for providing a visual simulation of water or other fluid displaced by a leading edge of a vessel; and

FIG. 4 illustrates one embodiment of a visually simulated bow wave of a tugboat displayed in connection with the ambient water and vessel.

Like reference symbols in the various drawings indicate like elements.

### DESCRIPTION

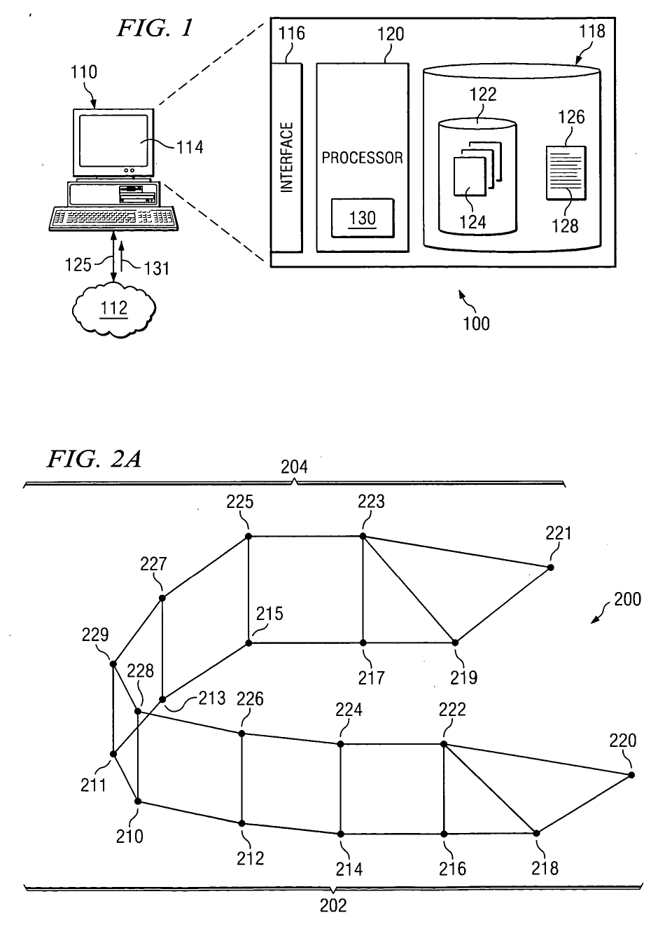

FIG. 1 illustrates one embodiment of a modeling system 100 for providing a visual simulation of water or other liquid displaced by a leading edge of a vessel. The leading edge may be a bow, a hydrofoil or other suitable structure that cuts through water. The vessel may be a boat, ship or other craft that travels in or on the water. The liquid displaced may be a bow wave or any other suitable liquid displaced by a leading edge of a vessel. System 100 will be described in connection with a visual simulation of a bow wave generated by a ship. However, system 100 may be used for any suitable traveling in or on a liquid. At a high level, system 100 may be a single computer 110 or any portion of a distributed or enterprise system including at least computer 110, perhaps communicably coupled to a network 112. For example, computer 110 may comprise a portion of an information management system or enterprise network that provides a number of software applications to any number of clients. Alternatively, computer 110 may comprise a client processing information in a distributed information management system or enterprise network via one or more software applications. In either case, system 100 is any system that generates a model of a bow wave based, at least in part, on ambient wave conditions and/or motional information of a corresponding vessel. This configuration often provides substantially realistic, flexible and inexpensive modeling of a dynamic three-dimensional wave effect at high frame rates and, based on the modeling, may provide a visual simulation of a bow wave.

Computer 110 includes a Graphical User Interface (GUI) 114, network interface 116, memory 118, and processor 120. FIG. 1 only provides one example of a computer that may be used with the disclosure. The present disclosure contemplates computers other than general purpose computers as well as computers without conventional operation systems. As used in this document, the term “computer” is intended to encompass a mainframe, a personal computer, a client, a server, a workstation, a network computer, a personal digital assistant, a mobile phone, or any other suitable processing device. Computer 110 may be operable to receive input from and display output through GUI 114.

GUI 114 comprises a graphical user interface operable to allow the user of computer 110 to interact with processor 120. The term “computer 110” and the phrase “user of computer 110” may be used interchangeably, where appropriate, without departing from the scope of this disclosure. Generally, GUI 114 provides the user of computer 110 with an efficient and user-friendly presentation of data provided by computer 110. GUI 114 may comprise a plurality of displays having interactive fields, pull-down lists, and buttons operated by the user. And in one example, GUI 114 presents an explorer-type interface and receives commands from the user. It should be understood that the term graphical user interface may be used in the singular or in the plural to describe one or more graphical user interfaces in each of the displays of a particular graphical user interface. Further, GUI 114 contemplates any graphical user interface, such as a generic web browser, that processes information in computer 110 and efficiently presents the information to the user. Network 112 can accept data from the user of computer 110 via the web browser (e.g., Microsoft Internet Explorer or Netscape Navigator) and return the appropriate HTML or extensible Markup Language (XML) responses.

Computer 110 may include network interface 116 for communicating with other computer systems over network 112 such as, for example, in a client-server or other distributed environment via link 125. In certain embodiments, computer 110 may generate requests and/or responses and communicate them to a client, server, or other computer systems located in network 112. For example, computer 110 may receive data for a visual simulation. Network 112 facilitates wireless or wireline communication between computer system 100 and any other computer. Network 112 may communicate, for example, Internet Protocol (IP) packets, Frame Relay frames, Asynchronous Transfer Mode (ATM) cells, voice, video, data, and other suitable information between network addresses. Network 112 may include one or more local area networks (LANs), radio access networks (RANs), metropolitan area networks (MANs), wide area networks (WANs), all or a portion of the global computer network known as the Internet, and/or any other communication system or systems at one or more locations. Generally, interface 116 comprises logic encoded in software and/or hardware in any suitable combination to allow computer 110 to communicate with network 112 via link 125. More specifically, interface 116 may comprise software supporting one or more communications protocols associated with link 125 and communications hardware operable to communicate physical signals.

Memory 118 may include any memory or database module and may take the form of volatile or non-volatile memory including, without limitation, magnetic media, optical media, Random Access Memory (RAM), Read Only Memory (ROM), removable media, or any other suitable local or remote memory component. In the illustrated embodiment, memory 118 includes a vessel repository 120 and modeling ruleset 126. Repository 120 comprises any storage media for the storage and retrieval of information. According to one embodiment, repository 120 comprises a relational database, such as Oracle, normally accessed through Structured Query Language (SQL) statements. Relational databases use sets of schemas to describe the tables, columns and relationships in the tables using basic principles known in the field of database design. Alternatively or in combination, repository 120 may comprise eXtensible Markup Language (XML) documents, flat files, Btrieve files, name-value-pair files or comma-separated-value (CSV) files. In the illustrated embodiment, repository 120 includes one or more vessel description files 124, but may include any other data, as appropriate.

Vessel description file 124 comprises rules, instructions, parameters, algorithms, or other directives used by computer 110 to describe a vessel and is accessible by processor 120. In one embodiment, the description may include a geometric information of the vessel, a maximum attainable speed, a maximum attainable turn rate, a maximum attainable bow width, a maximum attainable bow height, a combination of the foregoing or other suitable physical and/or structural parameters. It will be understood that while the bow is described as the leading edge of the vessel, this description analogously applies to any leading edge of a vessel operable to displace liquid. Additionally, liquid includes water, salt water, or any suitable liquid. The geometric information described by vessel description file 124 may include the geometry of a freeboard, beam, stem length, stem angle, bow width, bow length, bow flare angle, bow offset from the origin of the vessel, a combination of the foregoing, or other suitable geometric parameters. Each vessel description file 124 may be associated with disparate types of vessels (e.g., tugboat, destroyer, cruise lines, etc.) or a plurality of vessel description files 124 may be associated with a single type of vessel. Vessel description file 124 may be any suitable format such as, for example, an XML document, a flat file, CSV file, a name-value pair file, SQL table, or others. In one embodiment, XML is used because it is easily portable, human-readable, and customizable. Vessel description file 124 may be created by computer 110, a third-party vendor, any suitable user of computer 110, loaded from a default file, or received via network 112.

Returning to memory 118, modeling ruleset 126 comprises rules, instructions, parameters, algorithms, or other directives used by computer 110 to generate and dynamically or otherwise model a bow wave of one of vessel description files 124. The term “dynamically,” as used herein, generally means that the appropriate processing is determined at runtime based upon the appropriate information. As used herein, “select” means to initiate communication with, initiate retrieval of, or otherwise identify a dataset. Modeling ruleset 126 may be in any suitable format such as, for example, XML document, a flat tile, CSV file, a name-value pair file, SQL table, or others. Modeling ruleset 126 may be created by computer 110, a third-party vendor, any suitable user of computer 110, loaded from a default file, or received via network 106.

Modeling function 128 is one or more entries or instructions in modeling ruleset 126 that independently models one or more aspects of the right or left bow waves based on ambient wave conditions and/or motional information. As used herein, independently means that at least a part of the right bow wave and part of the left bow wave are adjusted based on different parameters and/or instructions. Aspects of the left or right bow wave may include height, width, texture rotation, point of contact, a combination of the foregoing, or others. Motional information includes speed and maneuvering information such as, for example, turn rate, roll angle, a combination of the foregoing or others. Modeling function 128 may comprise a mathematical expression based on any appropriate programming language such as, for example, C, C++, Java, Perl, or any other suitable programming language. For example, modeling function 128 may comprise an algebraic, trigonometric, logarithmic, exponential, a combination of the foregoing, or any other suitable mathematical expression. Moreover, different values of ambient wave conditions and motional parameters may be associated with disparate mathematical expressions. For example, modeling function 128 may comprise an algebraic expression for a first range of values and an exponential expression for a second range of values. Alternatively, modeling function 128 may comprise any appropriate data type, including float, integer, currency, date, decimal, string, or any other numeric or non-numeric format operable to identify a mathematical expression for modeling an aspect of a left or right bow wave.

It will be understood that the determinations of the left and right bow wave may be independent of or dependent on each other or, alternatively, may share the same modeling function 128. For example, modeling function 128 may define left or right width scale based on the ratio of the forward speed (e.g., knots) of a vessel to the maximum attainable speed (RMS), the ratio of the turn rate (e.g., degrees per second) of a vessel to the maximum attainable turn rate (RTR), and the ratio of the roll angle to 45 degrees—roll factor (RF). In this case, the left and right width scale are define as followed:
Left width scale=RMS−(RTR*RF)
Right width scale=RMS+(RTR*RF)
In one embodiment, the left and right width scales are within the range of approximately 0.0 to 1.0. As a vessel goes into a turn, the bow of the vessel is pushed forward and sideways, so the bow encounters more liquid on the inside of a turn. However, the roll angle counteracts this effect, and the equation above accounts for this effect. For example, turning left results in the left width side increasing and the right width side decreasing. Regarding a right turn, the converse analogously results in another example, modeling function 128 may define left or right height scale based an RMS, bow displacement (BD), and RF resulting in a height that is a percent of the available freeboard. In this example, the left and right height scale are define as followed:

If the roll angles is less than five degrees:
Height scale=RMS*BD

Otherwise:
Left height scale=(RMS*BD)+RF
Right height scale=(RMS*BD)−RF
In one embodiment, the left and right height scales have a maximum value of 2.0. As indicated by the equation, as the vessel moves downward, a larger bow wave is generated. As it moves up, the bow wave reduces in height. In this case, BD, in one embodiment, is based on the pitch angle (θₚ) in radians, the freeboard (FB), and heave at the center of the vessel (HC) and defined as followed:
BD=1.0−(½ waterline*θₚ+HC)/FB
The freeboard is the vertical length of the side of the hull that is above the water at the bow. It will be understood that BD may be otherwise suitably determined. In yet another example, modeling function 128 may define a texture rotation angle (TRA) based on a prior TRA (TRAₚ), RMS, delta frame time (DFT), and base texture rotation angle (BRA). In this example, the TRA is defined as followed:
TRA=TRAₚ−(BRA*RMS*DFT)

where:
BRA=1.5/(Rotation per unit length)*K
The parameter K may be a constant multiplier of the rotation speed and may be chosen empirically to speed up or slow down the texture animation. It will be understood that this exemplary modeling functions 128 are for illustration purposes only and may comprise other, different, or additional mathematical expressions (represented by none, some, or all of the illustrated expressions as well as those not illustrated) operable to generate and dynamically model left and right bow waves.

Processor 120 executes instructions and manipulates data to perform operations of computer 110. Although FIG. 1 illustrates a single processor 120 in computer 110, multiple processors 120 may be used according to particular needs, and reference to processor 120 is meant to include multiple processors 120 where applicable. In the illustrated embodiment, processor 120 executes modeling engine 130 at any appropriate time such as, for example, in response to a request or input from a user of computer 110 or any appropriate computer system coupled with network 112. Modeling engine 130 may provide one or more of the following features or functions: determining a bow wave at run-time, dynamically builds polygonal meshes for each frame, optimum triangle stripping, substantially ensure frame-to-frame coherence while operating at a high frame rate, eliminates, and reduces, or minimizes discontinuities or cracks from appearing between meshes.

Modeling engine 130 includes any suitable hardware, software, firmware, or combination thereof operable to perform, execute, or process the results of some or all of the following steps: receive from network 112 ambient wave conditions and motional information, retrieve mapping functions 128 from ruleset 126, retrieve vessel information from vessel description file 124, dynamically model a left and right bow wave, and present the left and right bow wave through GUI 114. Modeling engine 130 may be based on any appropriate computer language such as, for example, C, C++, Java, Perl, Visual Basic, and others. It will be understood that while modeling engine 130 is illustrated as a single multitasked module, the features and functionality performed by this engine may be performed by multiple modules. Moreover, modeling engine 130 may comprise a child or submodule of another software module, not illustrated, without departing from the scope of this disclosure.

Additionally, modeling engine 130 may be operable to visually simulate a bow wave based on generated models. Modeling engine 130 may receive ambient wave conditions and/or motional information from a separate process running on computer 110, GUI 114, network 112, or any other appropriate source. In the illustrated embodiment, modeling engine 130 receives ambient wave conditions and motional information from network 112 via response 131. All or a portion of response 131 may be received from any appropriate source such as, for example, a process running in network 112, a user of a client in network 112, a file stored in network 112, the National Oceanic and Atmospheric Administration, or others. Alternatively or in combination, ambient wave conditions and/or motional information may be received from a process running on computer 110, a user of computer 110, a file stored in computer 110, or other suitable sources. In summary, ambient wave conditions and motional information may be received, retrieved, determined, or otherwise identified in network 112 and/or computer 110. Based on the values of the ambient wave conditions, the motional information, and the vessel information, modeling engine 130 may determine disparate aspects of the left and right bow wave utilizing ruleset 126. For example, modeling engine 130 may compute the left and right height scale, at which point these scales may be multiplied by a maximum attainable bow height to determine the height of the left and right bow wave independently. Similarly, modeling engine 130 may compute the left and right width scale, at which point the scales are multiplied by a maximum attainable bow width to determine the width of the left and right bow wave independently.

After determining the various aspects of the left and right bow wave, mapping engine 130 may generate and present a graphical image of the ambient conditions, bow wave, and vessel through GUI 114. In one embodiment, modeling engine 130 generates a polygonal mesh including a left and right component and dynamically scales, rotates, and translates the left and right components independently of each other and based on the determined aspects. In this embodiment, texture is applied to the dynamic left and right components based on parameters such as, for example, rotation texture angle. Additionally, modeling engine 130 may determine a point of contact of the bow wave with the selected vessel based on pitch angle, angle and length of stem, and elevation of the liquid. For example, modeling engine 130 may begin by transforming the vertices of the stem from local to world space. Once transformed, modeling engine 130 may determine a unit (directional) vector from the bottom to the top of the stem. After completing the unit vector, modeling engine 130 may perform a binary search for identifying the point of contact. A binary search begins from the midpoint of the stem, i.e., at half the length of the stem. Modeling engine 130 may then query the liquid elevation at the midpoint. If the difference between the midpoint and liquid elevation is greater than a specified distance (e.g., 1/10 meter), then the search continues from the midpoint of the stem segment with the range of the liquid elevation. This iterative process continues until the liquid elevation is within the specified distance of a corresponding midpoint. The waterline length may affect the following: lateral velocity, roll angle, dampening of the bow wave, extent of draft, extent of vessel's power, a combination of the foregoing and others.

In one aspect of operation, vessel description file 124 is selected by computer 110 and vessel information is retrieved. After or in connection with this selection, modeling engine 130 receives environmental information and motional information from any suitable source, as discussed above. It will be understood that the environmental and motional information may be received from the same, disparate, or any combination of sources. Further, environmental information may include information regarding waves, wind, interference from another boat, or any suitable environmental condition. Once identified, modeling engine 130 retrieves one or more modeling functions 128 from ruleset 126. Based on the values of the environmental information and motional information, modeling engine 130 utilizes the retrieved one or modeling functions 128 to determine aspects of the left and right bow wave. After these determinations, modeling engine 130 generates and dynamically forms a polygonal mesh with left and right components that are independently scaled, rotated, and/or translated by the determinations. After generating the components, modeling engine 130 applies a texture (e.g., foam-like, animated texture) to the right and left components. Modeling engine 130 then presents the modeled bow wave, vessel, and ambient wave conditions through GUI 114 to provide a visual simulation of a bow wave. In one embodiment, the model may be provided to network 112. Furthermore, modeling engine 130 may update the existing polygonal mesh for a next frame or generate a new mesh for a next frame.

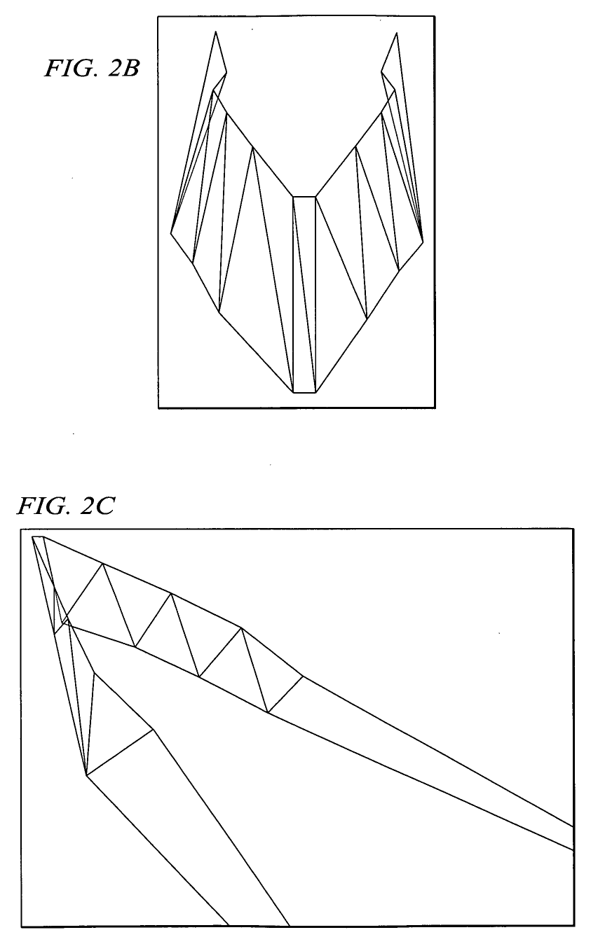

FIGS. 2A-C illustrate polygonal meshes that may be dynamically adjusted by modeling engine 130 to represent a bow wave. Referring to FIG. 2A, polygonal mesh 200 includes a left component 202 and a right component 204 representing a left and right bow wave, respectively. Polygonal mesh 200 depends on the unique vessel definition stored in vessel description file 124. For example, FIGS. 2B and 2C illustrated unique meshes for a tugboat and an LHA (amphibious assault ship) naval vessel wherein the polygonal mesh of FIG. 2A was applied to their unique bow geometry. As illustrated in FIG. 2A, left component 202 includes vertices 210, 212, 214, 216, 218, 220, 222, 224, 226, and 228. Vertices 210, 212, 214, 216, and 218 illustrate the point of contact of the bow wave with the port side of the hull, i.e., the waterline. Vertices 220, 222, 224, 226, and 228 extend up and out from vertices 210, 212, 214, 216, and 218 to provide width and height to left component 202 or the left bow wave In this embodiment, the vertices 210, 212, 214, 216, and 218 include a horizontal (or x) component and a vertical (or z) component. In one embodiment, a base state of the left component 202 may occupy a narrow region around the vessel and horizontal and vertical displacements are applied from this base state. Based on determinations made by modeling engine 130, the horizontal and vertical components are adjusted when the polygonal mesh 200 is update each frame. Modeling engine 130 applies a foam-like, animated texture to the surface defined by vertices 210, 212, 214, 216, 218, 220, 222, 224, 226, and 228. Similarly, the right component 204 includes vertices 211, 213, 215, 217, 219, 221, 223, 225, 227, and 229. Vertices 211, 213, 215, 217, and 219 represent the point of contact of the right bow wave with the starboard side of the hull. Vertices 221, 223, 225, 227, and 229 provide the width and height of the right bow wave as determined by modeling engine 130. A foam-like, animated texture is applied to the surface defined by vertices 211, 213, 215, 217,219, 221, 223, 225, 227, and 229.

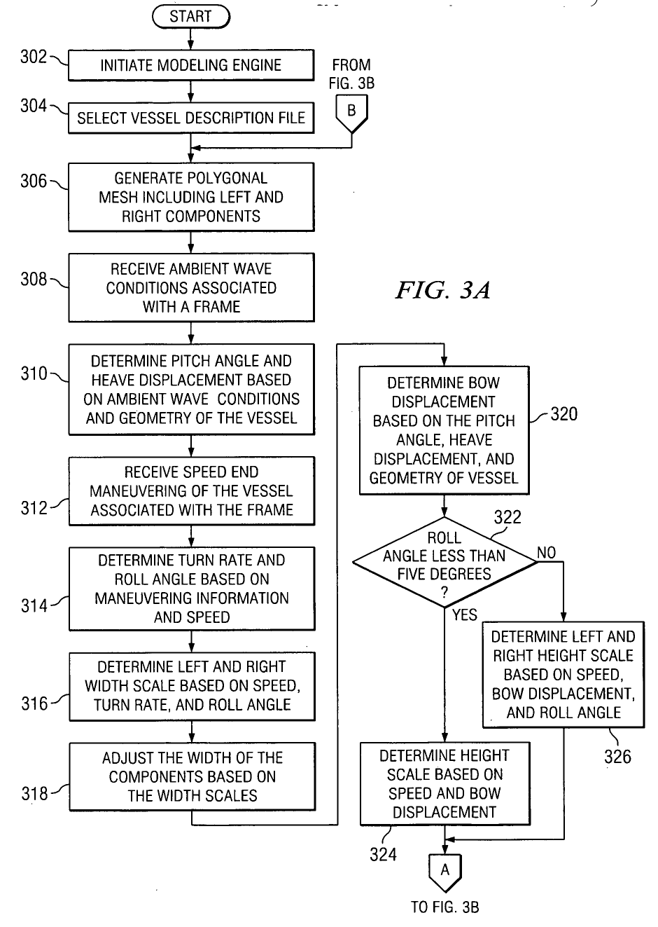

FIGS. 3A-B are an exemplary flow diagram illustrating a method 300 for procedurally generated geometry representing objects with real-time hydrodynamics and maneuvering. Method 300 is described with respect to system 100 of FIG. 1, but method 300 could also be used by any other system. Moreover, system 100 may use any other suitable techniques for performing these tasks. Thus, many of the steps in this flowchart may take place simultaneously and/or in different orders as shown. Moreover, system 100 may use methods with additional steps, fewer steps, and/or different steps, so long as the methods remain appropriate.

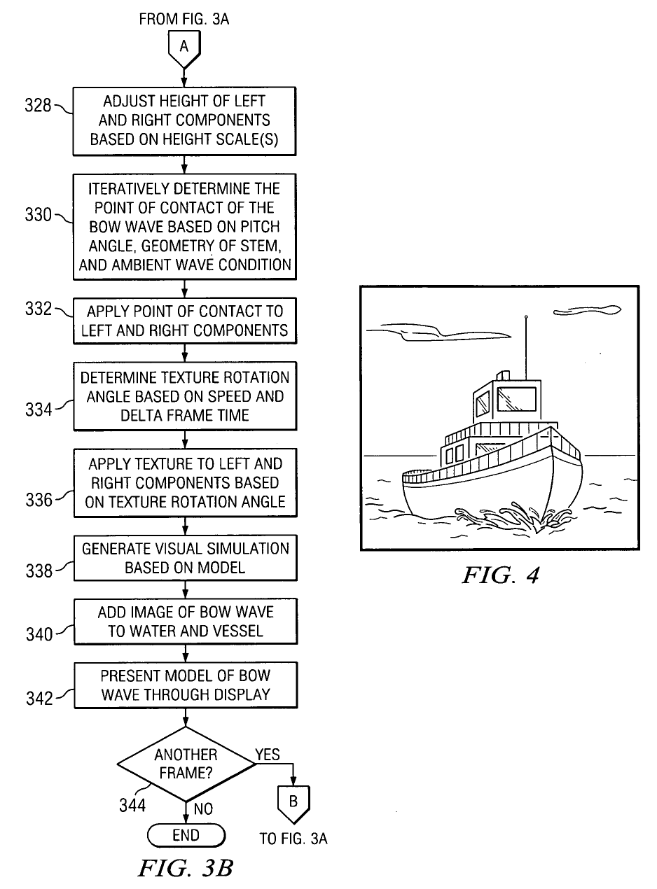

Method 300 begins at step 302 where modeling engine 130 is initiated. Next, at step 304, a vessel description file 124 is selected. For example, the selected vessel description file 124 describes a tugboat. Based on the selected vessel description file 124, modeling engine 130 generates a polygonal mesh including left and right components at step 306. Referring to the example, modeling engine 130 generates the right and left components for the tugboat as illustrated in FIG. 2B. Next, at step 308, modeling engine 130 receives ambient wave conditions associated with a frame (or time). Modeling engine 130 determines a pitch angle and heave displacement based on ambient wave conditions and geometry of the vessel at step 310. Next, at step 312, modeling engine 130 receives motional information including speed and maneuvering information of the vessel associated with the frame (or the time). Based on the motional information, modeling engine 130 determines a turn rate and roll angle of the vessel at step 314. At step 316, modeling engine 130 determines a left and a right width scale based on speed, turn rate, and roll angle. Based on these determinations, at step 318, modeling engine 130 adjusts the width of the left and right components based on the corresponding width scales. Next, at step 320, modeling engine 130 determines bow displacement based on the pitch angle, heave displacement, and geometry of the vessel. If the roll angle is less than 5″ at step 322, then, at step 324, modeling engine 130 determines a height scale based on speed and bow displacement. If the roll angle is greater than or equal to 5″ at, step 322, then, at step 326, modeling engine 130 determines a left and right height scale based on speed, bow displacement, and roll angle. Based on the appropriate determination, modeling engine 130, at step 328, adjusts the height of the left and right components based on respective height scales. Next, at step 330, modeling engine 130 determines, using an iterative process, the point of contact of the bow wave based on pitch angle, geometry of stem, and ambient wave conditions. Modeling engine 130 applies the point of contact determination to the left and right components at step 332. At step 334, modeling engine 130 determines a texture rotation angle based on speed and delta frame. Modeling engine 130, at step 336, applies the appropriate texture to the left and right components based on the texture rotation angle. Next, at step 338, modeling engine 130 generates a visual simulation of the model, and modeling engine 130 adds the model of the bow wave to the water and vessel at step 340. At step 342, modeling engine 130 presents the model of the left and right bow wave through a display such as, for example, GUI 114. For example, FIG. 4 illustrates one embodiment of a visually simulated bow wave of a tugboat displayed in connection with the ambient water and vessel. If another frame is to be determined at step 344, then execution returns to step 306. If another frame is not to be determined at step 344, then execution ends.

Although this disclosure has been described in terms of certain embodiments and generally associated methods, alternatives and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

1. A method for modeling liquid displaced by a leading edge of a vessel, comprising:
identifying environmental information associated with the liquid and motional information associated with the leading edge of the vessel; and
generating a model of the liquid displaced by the leading edge of the vessel based, at least in part, on the environmental and motional information.

2. The method of claim 1, further comprising generating a visual image of the displaced liquid based on the model.

3. The method of claim 1, further comprising:
identifying geometric information associated with the vessel;
determining a response of the vessel based, at least in part, on the environmental and geometric information; and
generating the model based, at least in part, on the response.

4. The method of claim 3, the response including at least one of pitch angle, heave displacement, waterline length, and a combination of the foregoing.

5. The method of claim 3, wherein the response comprises waterline length, pitch angle, and heave displacement, further comprising:
determining a height of the displaced liquid based, at least in part, on the response; and
generating a bow wave of the vessel based, at least in part, on the determined height.

6. The method of claim 3, wherein the response comprises pitch angle and the method further comprises:
determining a point of contact of the displaced liquid based, at least in part, on the response and the geometric information; and
generating a bow wave of the vessel based, at least in part, on the determined point of contact.

7. The method of claim 1, wherein the motional information comprises speed, turn rate, and roll angle and the method further comprises:
determining a width of the displaced liquid based, at least in part, on the motional information; and
generating a bow wave of the vessel based, at least in part, on the determined width.

8. The method of claim 1, the model comprising a polygonal mesh adjusted to the shape of the bow and based, at least in part, on the motional information.

9. The method of claim 1, the motional information including at least one of speed, turn rate, roll angle, and a combination of the foregoing.

10. The method of claim 1, the environmental information comprising ambient conditions.

11. The method of claim 10, the liquid comprising water and the ambient conditions comprising ambient wave conditions.

12. A method for simulating a bow wave, comprising:
identifying maneuvering information associated with the vessel; and
dynamically modeling a bow wave associated with the vessel based, at least in part, on maneuvering information.

13. The method of claim 12, further comprising generating a visual image of the displaced liquid based on the model.

14. The method of claim 12, further comprising:
identifying environmental information associated with the liquid and a speed associated with the leading edge of the vessel; and
generating a model of the liquid displaced by the leading edge of the vessel based, at least in part, on the environmental and motional information.

15. The method of claim 14, further comprising:
identifying geometric information associated with the vessel;
determining a response of the vessel based, at least in part, on the environmental and geometric information; and
generating the model based, at least in part, on the response.

16. The method of claim 15, the response including at least one of pitch angle, heave displacement, waterline length, and a combination of the foregoing.

17. The method of claim 15, the response comprising waterline length, pitch angle, and heave displacement and the method further comprises:
determining a height of the displaced liquid based, at least in part, on the response; and
generating a bow wave of the vessel based, at least in part, on the determined height.

18. The method of claim 15, the response comprising pitch angle and the method further comprises:
determining a point of contact of the displaced liquid based, at least in part, on the response and the geometric information; and
generating a bow wave of the vessel based, at least in part, on the determined point of contact.

19. The method of claim 15, the maneuvering information comprises turn rate and roll angle and the method further comprises:
determining a width of the displaced liquid based, at least in part, on the speed and the maneuvering information; and
generating a bow wave of the vessel based, at least in part, on the determined width.

20. The method of claim 12, the model comprising a polygonal mesh adjusted to the shape of the bow and based, at least in part, on the maneuvering information.

21. The method of claim 12, the maneuvering information including at least one of turn rate, roll angle, and a combination of the foregoing.

22. The method of claim 14, the environmental information comprising ambient wave conditions.

23. A method for simulating a bow wave, comprising:
generating a model of a bow wave for a vessel, the model representing water displaced by passing of the vessel and including a left and right components; and
independently distorting the left and right bow waves based, at least in part, on motion of the vessel.

24. The method of claim 23, wherein the left and right components each comprise a polygonal mesh.

25. The method of claim 23, wherein independently distorting the left and right components based, at least in part, on motion of the ship comprises independently scaling the left and right components based, at least in part, on the motion of the ship.

26. The method of claim 23, wherein independently distorting the left and right bow waves based, at least in part, on motion of the ship comprises independently rotating the left and right bow wave based, at least in part, on the motion of the ship.

27. The method of claim 23, wherein independently distorting the left and right bow waves based, at least in part, on motion of the ship comprises independently translating the left and right bow wave based, at least in part, on motion of the ship.

28. The method of claim 23, wherein independently distorting the left and right bow waves based, at least in part, on motion of the ship comprises independently distorting the left and right bow waves based, at least in part, on ambient wave conditions.

29. The method of claim 23, wherein generating a left and right bow wave for the vessel comprises generating a left and right bow wave for the vessel based, at least in part, on vessel parameters.

30. A method for modeling water displaced by a bow of a vessel, comprising:
identifying ambient wave conditions associated with the water and speed, turn rate, and roll angle associated with the bow of the vessel;
identifying geometric information associated with the vessel;
determining a pitch angle, heave displacement, and waterline length of the vessel based, at least in part, on the ambient wave conditions and geometric information;
determining a height of the bow wave based, at least in part, on the waterline length, pitch angle, and heave displacement;
determining a point of contact of the displaced liquid based, at least in part, on the pitch angle and geometric information;
determining a width of the displaced liquid based, at least in part, on the speed, turn rate, and roll angle;
generating a polygonal mesh comprising a right and left component; and
independently adjusting each component based, at least in part, on the height, point of contact and width.

31. Software for modeling liquid displaced by a leading edge of a vessel, the software operable to:
identify environmental information associated with the liquid and motional information associated with the leading edge of the vessel; and
generate a model of the liquid displaced by the leading edge of the vessel based, at least in part, on the environmental and motional information.

32. The method of claim 31, the software further operable to:
identify geometric information associated with the vessel;
determine a response of the vessel based, at least in part, on the environmental and geometric information; and
generate the model based, at least in part, on the response.

33. Software for simulating a bow wave, the software operable to:
identify maneuvering information associated with the vessel; and
dynamically model a bow wave associated with the vessel based, at least in part, on maneuvering information.

34. The software of claim 33, the software further operable to:
identify environmental information associated with the liquid and a speed associated with the leading edge of the vessel; and
generate a model of the liquid displaced by the leading edge of the vessel based, at least in part, on the environmental and motional information.

35. A system for modeling water displaced by a bow of a vessel, comprising:
memory operable to store ambient wave conditions associated with the water, and motional and geometric information associated with the vessel; and
one or more processors operable to:
identify ambient wave conditions associated with the water and speed, turn rate, and roll angle associated with the bow of the vessel;
identify geometric information associated with the vessel;
determine a pitch angle, heave displacement, and waterline length of the vessel based, at least in part, on the ambient wave conditions and geometric information;
determine a height of the bow wave based, at least in part, on the waterline length, pitch angle, and heave displacement;
determine a point of contact of the displaced liquid based, at least in part, on the pitch angle and geometric information;
determine a width of the displaced liquid based, at least in part, on the speed, turn rate, and roll angle;
generate a polygonal mesh comprising a right and left component; and
independently adjust each component based, at least in part, on the height, point of contact and width.
